(19) United States
(12) Patent Application Publication
(10) Pub. No.: US 2011/0298804 A1
(43) Pub. Date: Dec. 8, 2011

(54) VISUAL DISPLAY OF DATA FROM A PLURALITY OF DATA SOURCES

(76) Inventors: Ming C. Hao, Palo Alto, CA (US); Umeshwar Dayal, Saratoga, CA (US); Ram Ranganathan, Palo Alto, CA (US)

(21) Appl. No.: 12/795,580

(22) Filed: Jun. 7, 2010

(51) Int. Cl. G06T 11/20

(52) U.S. Cl. 345/440

(57) ABSTRACT

Systems and methods are provided for viewing, aligning, and correlating data in a visual display from data sources in data management systems. In one method, data sources in a data management system can be identified. Data attributes from the data sources can be displayed together as graphical cells over a common timeline as a reference for cell attribute columns. A first graphical cell in an attribute column at a time position on the common timeline can be selected. The graphical cell can represent a data record for a time measurement interval. A second graphical cell can be aligned with the first graphical cell based on the time position. The second graphical cell can be positioned in a same cell column as the first graphical cell and represent data obtained at a substantially same time as the data represented by the first graphical cell.

### BACKGROUND

Data management can include the creation, maintenance, and use of data sources. To manage a complex business intelligence workload, an administrator may analyze information from various data sources. When data sources include a large number of queries, limited computational resources may affect the performance of the data management system. As a result, the administrator may examine currently executing queries and related system metrics. For example, the examination of queries may help the administrator identify problem queries or queries exhibiting anomalous behavior. By identifying problem queries, the user may stop problem queries from executing so the problem queries do not inefficiently consume computer system resources.

To prevent a problem query from affecting the performance of the data management system, an administrator may have to identify the problem query or other data warehouse problems before or during execution. Many factors can cause slow system performance and the process of finding the cause of the poor performance may be tedious. For example, the data sources in the data warehouse may have a large volume of log files that store information about the queries, computer system resources, and system performance. To find the cause of the slow system performance, an administrator may analyze the log files for information to find the problem query. These log files may be large, multi-dimensional files with hundreds of attributes, and piecing information in the files together to find the desired information may be difficult and monotonous. In addition, identifying the problem query may use an inordinate amount of the administrator's time.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 is an illustration of a system configured to view, align, and correlate data in a visual display from a plurality of data sources in accordance with an embodiment;

FIG. 2 is a diagram of a process for converting information in a plurality of data sources into a visual display of data attributes in accordance with an embodiment;

FIG. 3 is an illustration of a visual display of data attributes in accordance with an embodiment;

FIG. 4 is an illustration of a visual display where different graphical cells are linked together in accordance with an embodiment;

FIG. 5 is a flow diagram of a method for drilling down into a visual display to view detailed information about a data attribute in accordance with an embodiment;

FIG. 6 is an illustration of a drilldown visual display in accordance with an embodiment;

FIG. 7 is a flow diagram of a method for aligning data in a visual display in accordance with an embodiment;

FIG. 8 is a flow diagram of a method for viewing data in a visual display in accordance with an embodiment; and

FIG. 9 is a flow diagram of a method for correlating data in a visual display in accordance with an embodiment.

### DETAILED DESCRIPTION

Alterations and further modifications of the inventive features illustrated herein, and additional applications of the principles of the present disclosure as illustrated herein, which would occur to one skilled in the relevant art and having possession of this disclosure, are to be considered within the scope of the present disclosure.

Systems and methods are provided to view, align, and/or correlate data from any number of data sources using graphical cells in a single view. In accordance with embodiments, the data can be temporal data and the view can be a temporal view. The correlation of data from the data sources can be a correlation at the record level. In one embodiment the graphical cells are pixel columns or are cells within pixel columns. To acquire information for identifying data management system problems, a user can analyze information from a plurality of data sources. The plurality of data sources may include query event log files and system resource consumption data repositories. The plurality of data sources can include data streams, databases, data warehouses, and virtually any other source of data.

A data source may contain a large amount of information. For example, a data source can contain thousands or millions of data records and each data record can include over a hundred data attributes. Because a user may have to search through multiple data sources to identify data management system problems, the large amount of information in the data sources may inhibit efficient identification of system and query problems. Therefore, an on-demand graphical representation of the data source can be provided to efficiently identify data management system problems and problem queries. This graphic representation can also help an administrator investigate the relationships between different data attributes despite the large size of the data repositories.

To efficiently help a user identify problem queries and data management system problems, a graphical representation may have certain characteristics. The graphical representation may allow a user to visually correlate data attributes from a plurality of data sources. The graphical representation may synchronize the different timestamps of information received from the data sources, such that measurements from the different data sources appear at the same time on a common timeline. Further, the graphical relationship may allow a user to drill down into a visual display of many data attributes to view relations between data attributes at the record level across different data sources and/or at different time intervals.

The present disclosure provides systems and methods for providing a visual display of data attributes from a plurality of data sources. The visual display may allow a user to visually correlate data attributes from a plurality of data sources in a single view using a graphical representation in a common timeline. In addition to allowing a user to visually correlate data attributes, the system can also perform the correlation and provide a display of the correlation to the user. The system can further be configured to align data attributes and display data attributes to the user. The systems and methods can enable a single view of data attributes from multiple scattered data sources using graphical cells arranged in columns and synchronized with a common timeline.

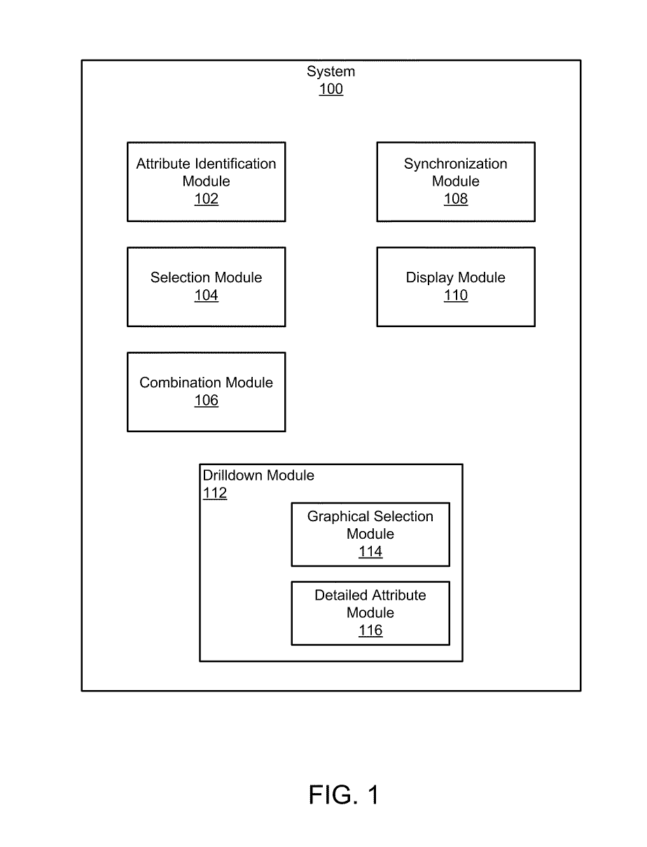

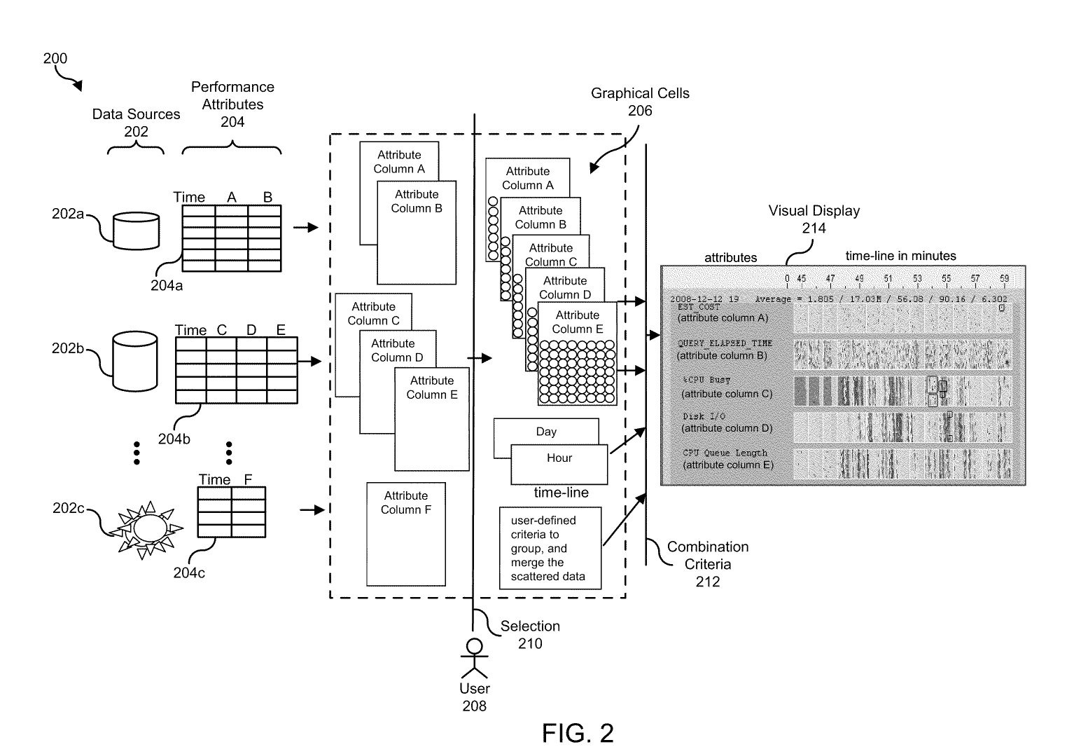

FIG. 1 illustrates an exemplary system 100 for creating a visual display of data attributes. The system 100 may comprise an attribute identification module 102, a selection module 104, a combination module 106, a synchronization module 108, a display module 110, and a drilldown module 112. In embodiments, the attribute identification module 102 can identify data attributes from a data source. The selection module 104 can select data attributes for displaying to a user. Further, the combination module 106 can combine data attributes into a quantified display attribute. In embodiments, the synchronization module 108 can synchronize the timestamps of data attributes, measured at different times, to appear at the appropriate location on a common timeline. The display module 110 can display a graphical representation of the quantified display attributes to a user. Further, the drilldown module 112 can provide detailed information about a data attribute to a user. The drilldown module can enable drilldown from queries to an individual CPU without aggregation of CPUs. For example, the display can show a single CPU which is an aggregation of 16 CPUs, or alternatively can show individual CPUs from which drilldown is enabled. According to an embodiment, the drilldown module 112 may comprise a graphical selection module 114 and a detailed attribute module 116. The graphical selection module 114 may allow the user to select a graphical representation of a data attribute. The detailed attribute module 116 may provide detailed information associated with the data attribute. The modules in the system 100 can perform the methods for providing a visual display of data attributes. As used herein, “data attribute” refers to information about or a representation of raw data. For example, a data attribute may be a characteristic of a block of data, such as “query elapsed time” in a query data source, or “% CPU busy” in a system performance data source, as illustrated in FIG. 2.

FIG. 2 illustrates a block diagram of system and process 200 for visually correlating a data management system's data attributes. The process 200 can comprise a plurality of data sources 202a-c, a plurality of data attributes 204a-c, a plurality of graphical cells 206, a user 208, a selection 210, combination criteria 212, and a visual display 214. The graphical cells 206 can be arranged in attribute columns and pixel columns as shown in the display 214 to provide a single view of the attributes from multiple sources as shown. As used herein, “graphical cell” refers to a unit for display. The graphical cell may be a block, a graphic, a pixel, a group of pixels, a pel, a half-pixel, a quarter pixel, or any other suitable unit for display. In accordance with embodiments, the cell may be used to represent a measurement or a data attribute through display of color, as will be further described herein.

In at least one embodiment, the plurality of data sources 202 may comprise data records that store information related to a database or other data warehouse data source component. The information stored in the plurality of data sources may describe the performance of the data management system. For example, a data source can contain measurements of query performance. Measurements in a query performance data source may measure the estimated cost of a particular query or the elapsed time since a query began execution. In another example, a data source may contain measurements of the performance of system resources. Measurements in a system resource performance data source may measure disk I/O, queue length for queries, or the central processor usage, etc.

In certain embodiments, query data sources and system resource data sources may store information related to a data warehouse and/or a database in log files. The data sources 202a-c may represent a plurality of log files. The data sources can also provide live or streaming data. The attribute identification module 102 in FIG. 1 can search the data sources 202a-c for data attributes. For example, the attribute identification module can search the data source 202a and may find the data attributes A and B stored in the data source. The measurements in the data source 202a may have been stored at a measuring period of time T. Also, the attribute identification module can search the data source 202b and may find the data attributes C, D, and E stored in the data source. The measurements in the data source may also have been stored at the measuring period of time T. Further, the attribute identification module may find the data attribute F stored in the data source 202c. The measurements in the data source may have also been stored at a measuring period of time T. Alternatively, the various measurements may have been stored at differing time periods, such as T+1, T+2, etc.

In at least one embodiment, after the attribute identification module identifies the plurality of data attributes 204a-c contained in the plurality of data sources 202a-c, the selection module 104 in FIG. 1 may display a list of identified data attribute names to a user 208. The phrase “data attribute name” represents a title or classification of a set of data management system data attributes. The selection module may prompt the user 208 to select data attribute names associated with the data attributes that will be visually displayable. For example, in FIG. 2, at the selection 210, the user 208 may select the data attributes associated with the data attributes A, B, C, D, and E for visual display. The selected data attributes may have timestamps of time T and time T+1. In the example, the user did not select the data attribute name associated with the data attribute F. After the user 208 makes the selection, the display module 110 in FIG. 1 may create graphical representations of the user selected data attributes as shown in FIG. 2.

Further, after the user 208 has selected the data attributes for visual display, the combination module 106 in FIG. 1 may apply a combination criteria 212 to combine the data attributes into a quantified display attribute. The phrase “quantified display attribute”, as used herein, refers to a representation value or rating of a data attribute and related information. A quantified display attribute can allow a user to compare the values of different data attributes. For example, the quantified display attribute representing the data attribute for processor performance may comprise a value of currently used processor resources. A user may compare the values for processor performance at one measurement time with the values for processor performance measured at a different time.

In certain embodiments, the quantified display attribute may match the underlying data attribute. The combination criteria for the data attribute may indicate that the value stored in the data source is displayable as a quantified display attribute and therefore may not be combined with other information. For example, a data attribute representing the elapsed time for an executing query may be displayable as a quantified display attribute. The elapsed time measurement may record a query that takes one megacycle (or any other period of time) to find the desired data. The value of one megacycle may form the quantified display attribute. In accordance with embodiments, the combination module can identify a stored combination criteria, where the stored combination criteria is associated with the data attributes. In another embodiment, the combination module may prompt a user to enter new combination criteria for combining information in a data stream to create display values for the set of data attributes. In certain embodiments, the combination module may use the data received from the data attribute data stream as the quantified display attribute by applying a combination criteria that indicates that the information in the data attribute data stream is readily displayable as a quantified display attribute.

In some embodiments, multiple measurements stored in the data source may correspond to the selected data attribute. The combination module 106 can combine the measurements stored in the data source to form the quantified display attribute in a common timeline. For example, the combination module may combine data attributes from data sources to form a quantified display attribute that shows the estimated cost of executing a particular query.

After the combination module combines the data attributes into quantified display attributes, the synchronization module 108 in FIG. 1 may synchronize time stamps of data attributes received from data sources, such as data streams, with the common timeline. In some embodiments, the synchronization module may adjust the timestamps for the measurements of the data attributes. The synchronization module may adjust the timestamps so that measurements taken at different times of data attributes appear at the same temporal location on a timeline. For example, in FIG. 2, data attributes A-B were measured with a period of time T and data attributes C-E were also measured with a period of time T. The synchronization module can adjust the timestamps associated with the measurements so that data attributes A-B appear at the same location on a common timeline as data attributes C-E. By synchronizing the timestamps to a common timeline, the display module 110 in FIG. 1 may display the information from a plurality of data sources at the same time location on the timeline.

After the synchronization module 108 synchronizes the received data and the combination module 106 combines the data attributes into quantified display attributes, the display module 110 in FIG. 1 can display the quantified display attributes on a common timeline in the visual display 214. The visual display 214 can show graphical cells that represent the quantified display attributes. The graphical cells are graphical representations of the quantified display attributes. For example, a graphical cell may comprise a pixel with an assigned pattern or color, where the pattern represents a specific attribute value. As the system receives more information from the data sources, the display module can arrange a plurality of graphical cells into a column of graphical cells associated with a time period on the common timeline. For example, the column of graphical cells may comprise a plurality of pixels arranged into a column of pixels. A graphical cell or pixel may include just one hardware display element on a physical display (e.g., a pel) or a small group of physical display elements.

The visual display 214 may allow a user to view many different data attributes simultaneously. Further, the graphical cell representation of the data attributes can allow the user to visually correlate different data attributes. The user 208 may both visually correlate by visually inspecting the visual display or the user can select a graphical cell in the visual display to see other graphical cells linked to the selected graphical cell on the common timeline. For example, by selecting a graphical cell and viewing the other linked graphical cells, the user 208 may drilldown into the display and identify a problem query. The correlation will be explained in more detail below. The visual display can allow the user to quickly identify problem queries without extensive searching of the log files.

As used herein, the terms “column” and “row” may be interchangeable. For example, in FIG. 2, the display may include data attribute columns which are horizontally arranged according to vertically oriented pixel columns aligned with a common timeline.

In another example, time represents a data attribute arranged in vertical columns by which other data attributes are arranged in rows, or horizontally oriented data attribute columns. In one aspect, a user can select one or more attributes to be arranged in rows and one or more other attributes to be arranged in columns.

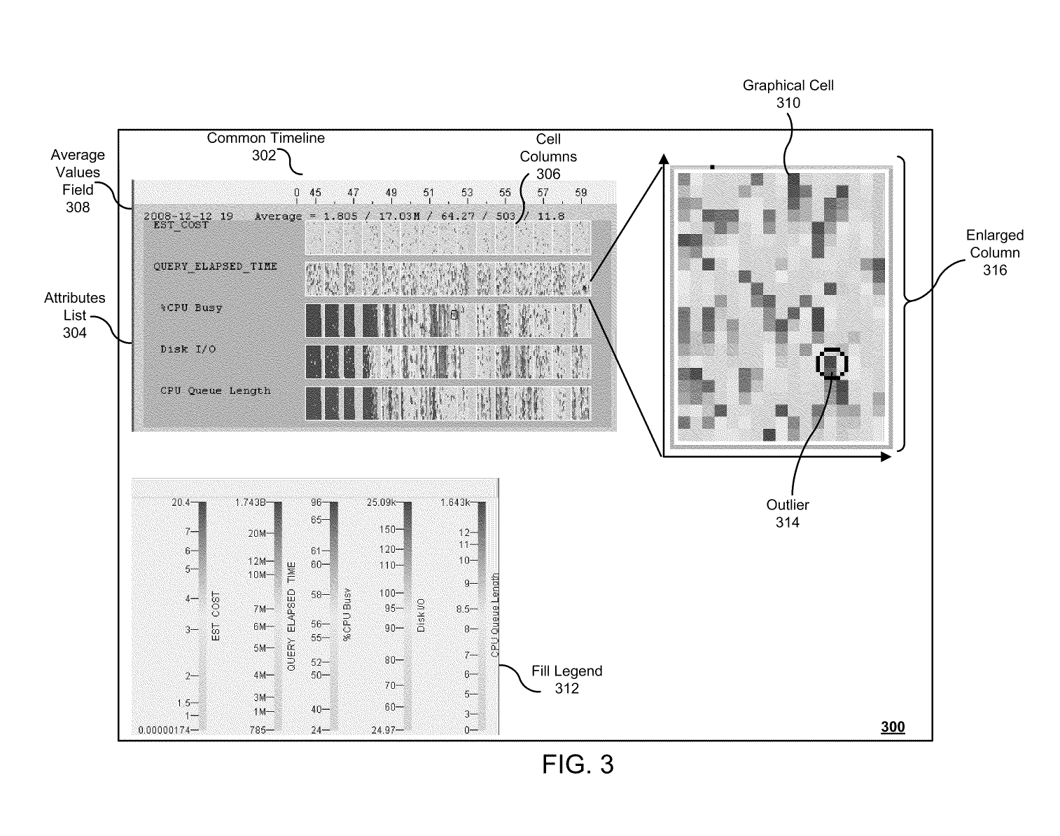

In one embodiment, FIG. 3 illustrates a visual display 300. The visual display 300 may comprise a common timeline 302, an attributes list 304, graphical cell columns 306, an average values field 308, a graphical cell 310, a fill legend 312, an outlier 314, and an enlarged column 316. The visual display can display data attributes according to color. For example, the fill legend shows that a longer CPU queue length or high query elapsed time may be shown in red and a shorter queue length or low query elapsed time may be shown in green. A user can therefore quickly ascertain problem areas by looking, for example, for cells with a red color in the display.

In certain embodiments, the attributes list 304 may comprise a listing of the attributes that are viewable to the user. For example, the attributes list 304 may comprise the attributes that were selected for visual display by a user or the system. The display module can display the attributes such that a user may identify the relationship between the various data attributes. For example, in visual display 300, the attribute list 304 may comprise a list of selected data attributes. The data attributes in the attribute list 304 may describe the horizontal rows of graphical cells 306.

In at least one embodiment, the graphical measurement columns 306 may contain a plurality of graphical cells. The display module may display a plurality of graphical measurement columns 306 in a grid organized horizontally according to a time the data for the data attribute was received from the data source and vertically according to the measured data attribute. For example, the data attribute estimated cost “EST_COST” in the attributes list 304, may have aggregated graphical cells at each sample time on the common timeline. The display module displays the graphical cell columns 306 to the user so that the user can visually correlate the measurements of multiple data attributes in a single view as will be explained in more detail.

In certain embodiments, the enlarged column 316 provides a detailed view of a column in the graphical cell columns 306. The enlarged column 316 contains a plurality of graphical cells 310. Each graphical cell represents a quantified display attribute from a data source. As the display module receives quantified display attributes, the display module may display the quantified display value as a graphical cell 310. The graphical cell may comprise a pixel or a group of pixels. The display module may arrange the blocks in the order that they are received starting from the bottom-left corner of the enlarged column 316 towards the top-right corner of the enlarged column 316 as shown in FIG. 3. The display module 110 may display the graphical cells in an order that allows visual correlation between different data attributes. In at least one embodiment, as the display module displays a quantified display attribute as a graphical cell 310, the display module assigns the graphical cell 310 a fill pattern or color. The fill pattern or color corresponds to a specific value for the quantified display attribute. The fill pattern may comprise a specific color, a grayscale value, a hatch pattern, etc. For example, the fill legend 312 can associate particular fill patterns with numeric values for the data attributes.

In a further embodiment, when a particular quantified display attribute exceeds a predefined value for the data attribute, the display module may mark the graphical cell associated with the exceptional quantified display value as an outlier. The display module may mark a graphical cell as an outlier by changing the fill pattern to a pattern not represented in the fill legend, or by applying a label or a marking to the graphical cell that indicates that the graphical cell is an outlier. For example, the display module marked the outlier 314 by changing the fill pattern and outlining the border of the graphical cell associated with the outlier 314.

In certain embodiments, the display module may find the average value of each data attribute for the quantified display attributes currently displayed on the visual display 300. For example, the data attribute “estimated cost” may have an average value of 1.805 over the time period (45-59 minutes) displayed on the visual display 300. The display module may display the average values for the data attributes in the attributes list 304 in the average values field 308.

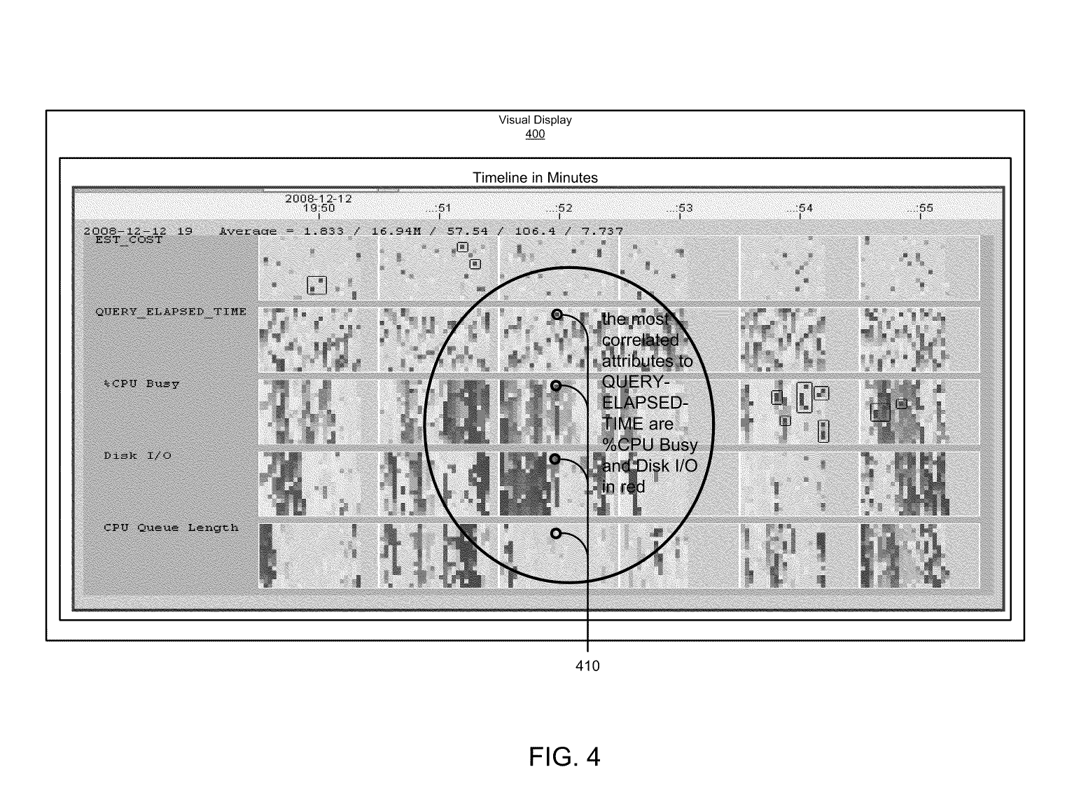

In certain embodiments, the display module 110 (FIG. 1) may link graphical cells together. The term “link,” as used herein, generally refers to different measurements of quantified display attributes that are synchronized to the same location on the common timeline. For example, if several graphical cells are associated based on time or based on the same data source, the display module may link the associated graphical cells and associated information together. FIG. 4 illustrates a visual display 400 that contains linked graphical cells 410. The attribute identification module and the display module may link a first graphical cell associated with the first data attribute with a second graphical cell associated with the second data attribute. In one embodiment, the display module may display the first and second graphical cells at the same temporal location on the common timeline. Alternatively, the first and second graphical cells can be linked based on other relationships such as locations of nodes in a network or spatial linking.

In certain embodiments, when a user selects a graphical cell in linked graphical cells 410, the display module can mark the other graphical cells in the visual display that are associated with the selected graphical cell. This may help the user identify a problem source. For example, a user may select a graphical cell indicating that the CPU is exceptionally busy. The display module can mark another graphical cell associated with the selected graphical cell. The user may then notice, for example, that at the same time on the common timeline that the CPU is busy (red), there is also an exceptionally high disk I/O (red) and long query elapsed time (red). The user may use this information to correlate the quantified display attributes and determine the root causes of poor performance. For instance, continuing with the example of the busy CPU, the user may determine that the high disk I/O is causing the CPU to be exceptionally busy and causing the long queries to execute for extended periods of time.

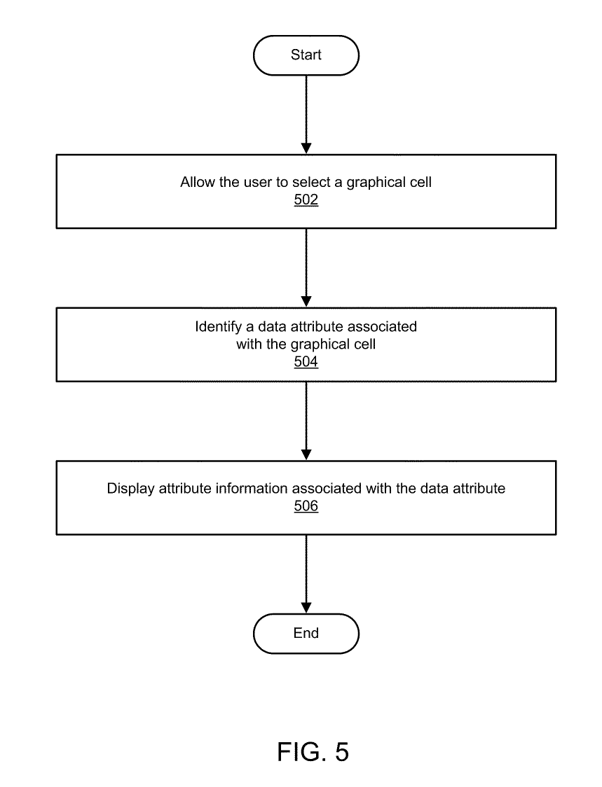

FIG. 5 illustrates a method for allowing a user to drill down into a visual display to view detailed information at the record level. For example, the drilldown module of FIG. 1 may allow a user to drill down into the visual display to view detailed information about the data attributes. In operation 502, a user is allowed to select a graphical cell. For example, the graphical selection module may allow a user to click on or select a particular graphical cell. After a user selects a graphical cell, in operation 504, a data attribute associated with the graphical cell may be identified. For example, the graphical selection module may identify the data attribute associated with the selected graphical cell. Then, in operation 506, attribute information associated with the data attribute may be displayed. For example, the detailed attribute module may display detailed information about the data attribute associated with the graphical cell to the user. In another embodiment, the detailed attribute module may also display detailed information about other data attributes that are linked to the selected graphical cell. Drilling down into linked data attributes may further allow a user to visually identify data management system problems.

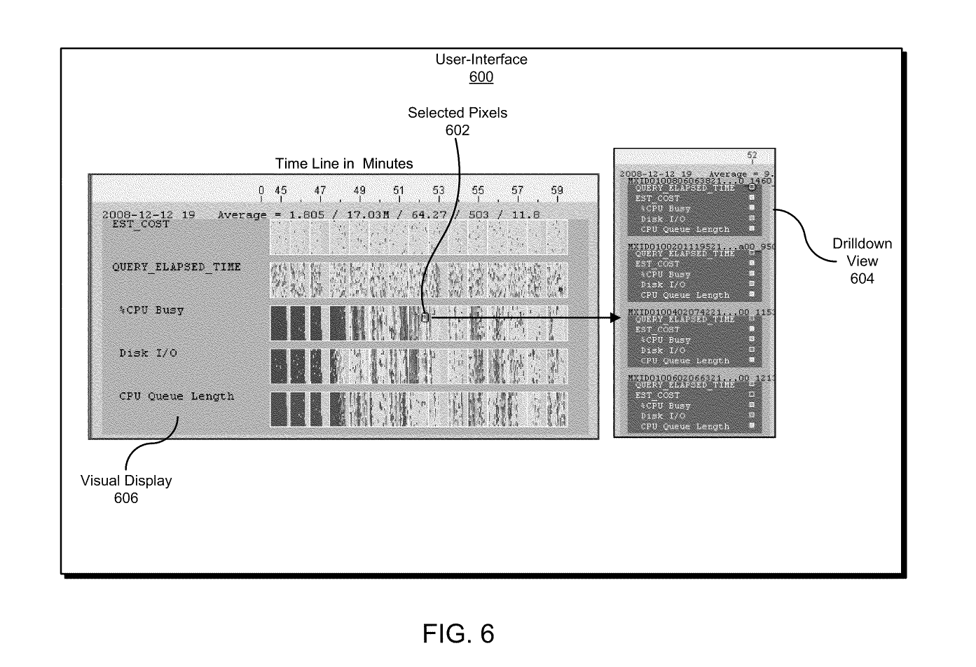

FIG. 6 shows a user-interface 600 that can show detailed information about a particular data attribute. The user-interface 600 may comprise a visual display 606, one or more selected pixels 602, and a drilldown view 604. The visual display is similar to the visual display 300 shown in FIG. 3. A user may select the selected pixels 602 for drilldown display. After the user selection, the detailed attribute module 116 in FIG. 1 may identify the data attribute associated with the selected pixels 602. After the detailed attribute module identifies the data attribute, the detailed attribute module can display detailed information about the data attribute to the user in the drilldown view 604. For example, a user may use the drilldown view of a query elapsed time to see why a query is taking so long. In this example, the user can see that the disk I/O is red and is a likely source of the lengthy query elapsed time. In accordance with embodiments, the user may further drill down from the disk I/O seen in the drilldown view 604 to see specific data causing blockage in disk I/O.

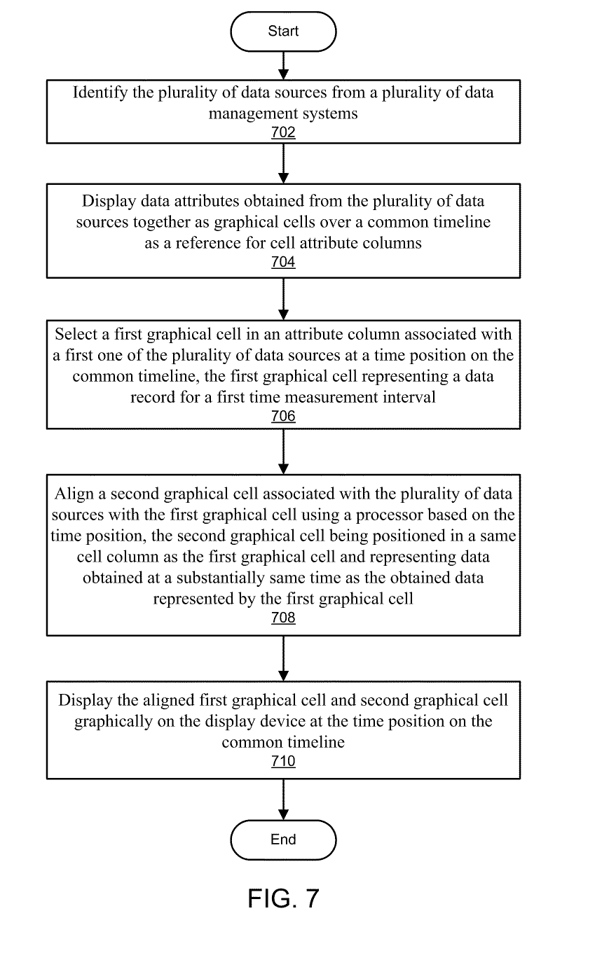

FIG. 7 illustrates a detailed method for aligning data in a visual display from a plurality of data sources in a data management system. In operation 702, a plurality of data sources in a database management system are identified. For example, the attribute identification module may identify a plurality of data sources in a data management system. As the data management system manages one or more data sources, databases, and the like, the data management system may store information about the data sources in log files. The data in log files may contain query performance measurements, system resource usage information, and other data management system metrics. System resource performance or usage information may comprise, for example, disk I/O, processor consumption, the length of the queue containing instructions for the processor, the amount of memory consumed, and so forth.

In one example, the attribute identification module may periodically receive a data attribute data stream comprising data attributes. For example, the attribute identification module may receive a data attribute data stream from a particular data source one time per second. The phrase “data attribute data stream,” as used herein, represents a received packet of information, where the information may provide the value of a data attribute. In certain embodiments, the attribute identification module 102 may receive a plurality of data attribute data streams comprising information related to a single data attribute. In another embodiment, a data attribute data stream may contain information related to a plurality of data attributes. The attribute identification module may use the information received from a data attribute data stream to form a single data attribute or a plurality of data attributes.

After the attribute identification module identifies the plurality of data sources, in operation 704, data attributes obtained from the plurality of data sources can be displayed together as graphical cells over a common timeline as a reference for cell attribute columns. In other words, data displayed in a cell attribute column can be organized according to time of occurrence by referencing the timeline, or the cell attribute columns can be organized according to time of occurrence along the common timeline. The data attributes can be displayed on a display device. The display device can include any suitable device as is known in the art, including, but not limited to, projectors, monitors, LCD screens, etc.

In operation 706, a first graphical cell can be selected. The first graphical cell can be in an attribute column associated with a first one of the plurality of data sources at a time position on the common timeline. The first graphical cell can represent a data record for a first time measurement interval. The time measurement interval can be identified on the common timeline. For example, the time measurement interval may be a period of seconds, minutes, hours, etc. In other words, the time measurement interval can be any suitable interval useful for identifying, viewing, displaying, and/or correlating data from the plurality of data sources during one or more time measurement intervals. In accordance with embodiments, the time intervals can be determined based on a frequency of network event occurrences, such that a system with a greater amount of network occurrences may display shorter time intervals than a system with fewer such occurrences to allow an administrator to more effectively view and correlate data attributes. In accordance with embodiments, the system may be configured to automatically adapt a time interval to a system based on various factors, such as user input, data received, network occurrences, etc. The time intervals can be fixed intervals such that regardless of where on a timeline a user views data attributes, the time interval will be the same as any other position along the timeline.

In operation 708, a second graphical cell associated with the plurality of data sources can be aligned with the first graphical cell using a processor. The alignment can be based on a time position. For example, the second graphical cell can be positioned in a same cell column as the first graphical cell and represent data obtained at a substantially same time as the obtained data represented by the first graphical cell. In other words, data obtained at a same time from a plurality of different sources can be aligned at a substantially same position on the common timeline.

In operation 710, the aligned first graphical cell and second graphical cell can be displayed graphically on the display device at the time position on the common timeline.

In accordance with embodiments, the method can include identification of data attributes in the plurality of data sources. For example, the attribute identification module may identify a plurality of data attributes in the plurality of data sources. For instance, a data source may comprise a log file that contains information related to the performance of queries. The attribute identification module may parse the information in the log file to identify query data attributes. In a different example, the attribute identification module may identify system performance measurements in a system performance data source to identify the possible data attributes.

In certain embodiments, the attribute identification module may identify more data attributes than a visual display can show to a user or more than may be useful to a user. Therefore, the method can include selection of one or more data attributes from the plurality of data attributes for visual display. For example, the selection module may display data attribute names to a user and prompt the user to select the data attribute names associated with the data attributes that will be visually displayed.

In one aspect, the selection module may select the data attributes without prompting a user to make a selection. The selection module may select a default set of data attributes. In a further embodiment, the selection module may apply pre-determined selection criteria to select the data attributes for display. The selection module may perform a combination of the user selection, default selection, or computer selection of the data attributes for visual display to the user. Further, the selection module may allow the user to select a subset of the data attributes that were selected for visual display. For instance, a user-interface may display a list of the data attributes identified and prompt the user to select the data attributes that will be displayed for visual analysis. In an alternative embodiment, the selection module may display the data attributes that have been identified and prompt the user to select the data attributes that will be displayed to the user.

According to some embodiments, after the selection module selects the data attributes for display to a user, a first data attribute can be linked to a second data attribute. A first graphical cell associated with the first data attribute can be linked with a second graphical cell associated with the second data attribute based on a measurement time period. A user can be allowed to drilldown from the graphical cells to view detailed information about the first and second data attributes.

After the selection module selects the data attributes for display to a user, combination criteria can be used to form a quantified display attribute from the data attribute. For example, the combination module may determine a combination criteria for combining the data attributes to form a quantified display attribute for visual display. For some data attributes, the quantified display attribute may be just one data attribute. For example, a data attribute representing the elapsed time for an executing query may be displayable as a quantified display attribute. A query may execute for one megacycle. The elapsed time of the query contrasts against an elapsed time value from a different query. Therefore, the graphing of the two different elapsed time values can allow a user to compare the values of the quantified display attribute.

However, in certain embodiments, a data attribute may contain a plurality of data records that the combination module can combine to form a quantified display attribute. For example, a data attribute for estimated cost may include information related to the elapsed execution time for a query, the resources that the query consumes, and the availability of the consumed resources. The information contained in the estimated cost data attribute may not be displayable as a graphical cell that a user can meaningfully analyze. Therefore, the combination module may apply the combination criteria to the data attribute to form a quantified display attribute. For the example of the estimated cost data attribute, the combination criteria may comprise a mathematical formula for combining the query elapsed time with the resources consumed by a particular query to arrive at a numeric value representing the estimated cost of executing the query.

After the combination module determines the combination criteria for a data attribute, a graphical cell for the quantified display attribute is created. For example, the display module may create a graphical cell from the quantified display attribute. As stated above, the graphical cell may comprise a pixel displayed in a column of pixels, where the pixels in the column of pixels represent the quantified display attributes for a plurality of data attributes. The graphical cell may also comprise an aggregation of pixels to represent a data attribute. The graphical cells can comprise a small-sized block representation that allows the display module to display a large plurality of quantified display attributes in a single visual display. For example, one or more graphical cells can represent aggregated data values from 16 CPUs. In one aspect, the aggregated data values can be added together and averaged. Therefore, the graphical cells can be used for one to many or many to one display of data attributes. In other words, a single cell can represent an aggregation of many attributes or sources and drilldown from a single graphical cell can provide display of the many data attributes or sources separably. In other examples, a single cell or group of cells can represent a single data value or query.

In accordance with other embodiments, the method shown in FIG. 7 may further include correlating the second graphical cell associated with at least one of the plurality of data sources with the first graphical cell using a processor based on the time position. The second graphical cell can be positioned in a same cell column as the first graphical cell and represent data obtained at a substantially same time as the obtained data represented by the first graphical cell. The correlation of the first graphical cell and the second graphical cell can be displayed graphically on the display device at the time position on the common timeline. For example, after the cells have been aligned, a user may select one or more cells, such as to view more information about the one or more cells. Cells may be selected, for example, by moving a cursor (via a mouse or other input device) over a cell and clicking on the cell. In another example, one or more cells can be selected by clicking and dragging the mouse to form a box, circle, or other shape to enclose one or more desired cells for selection. The system can be configured to identify a corresponding cell in a different data attribute column and mark the cell so that a viewer can easily identify a correlated cell. For example, referring to FIG. 4, if a user were to select a cell in the CPU Busy column, a cell representing data obtained at a substantially same time from one or more different data sources (e.g., query elapsed time, disk I/O, queue length, etc.) can be identified. The system can select the identified cells and/or mark the cells in a manner easily viewable by the user. For example, in FIG. 4, the system can place a circle around the identified cells. Other examples of marking include highlighting, changing the color of the cell, using arrows, etc.

The displayed data attributes of FIG. 7 may comprise a representation of actual data obtained. The method may also further comprise displaying the actual data corresponding to the displayed data attributes in the first graphical cell at the time position. A user may be allowed to drill down from the graphical cells to view detailed information about the first data attribute. For example, a user may drill down by double clicking a mouse over the graphical cells or by right clicking and selecting an option or by using an option available from a menu system. Other methods of drill down, such as keyboard stroke, etc. are also contemplated. In one aspect, allowing a user to drill down can include allowing the user to select a graphical cell; identifying a data attribute associated with the graphical cell; and displaying data attribute information associated with the data attribute.

The method can also include correlating the second graphical cell associated with at least one of the plurality of data sources with the first graphical cell using a processor based on the time position, the second graphical cell being positioned in a same cell column as the first graphical cell and representing data obtained at a substantially same time as the obtained data represented by the first graphical cell. The correlation of the first graphical cell and the second graphical cell can be displayed graphically on the display device at the time position on the common timeline. The user can then be allowed to drilldown from the graphical cells to view detailed information about the correlated first and second graphical cells.

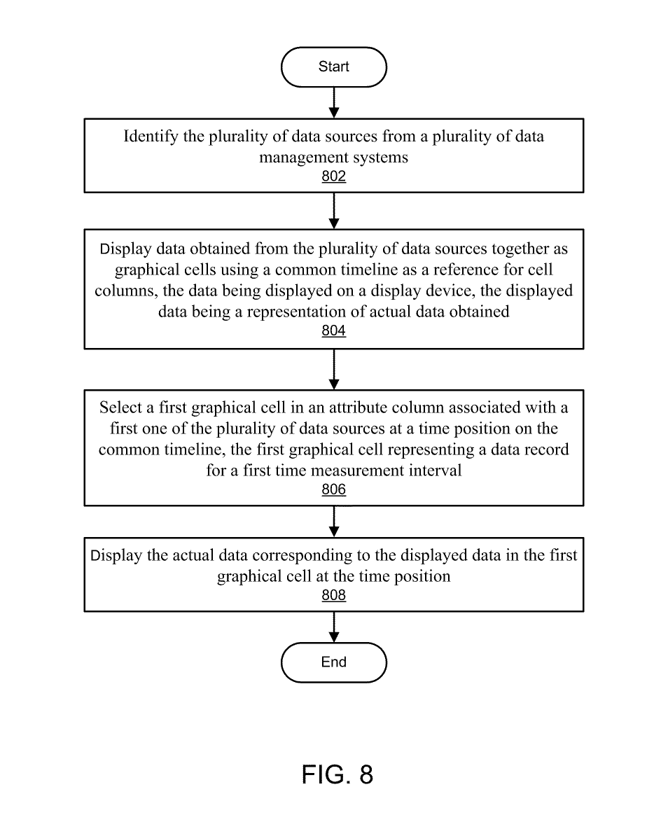

FIG. 8 illustrates a detailed method for viewing data in a visual display from a plurality of data sources in a data management system. In one aspect, the plurality of data sources can include various sources such as query performance data streams, system resource performance data streams, etc. In operation 802, the plurality of data sources from a plurality of data management systems can be identified. In operation 804, data obtained from the plurality of data sources can be displayed together as graphical cells using a common timeline as a reference for cell columns. The displayed data can be a representation of actual data obtained. A first graphical cell can be selected in an attribute column associated with a first one of the plurality of data sources at a time position on the common timeline in operation 806. The first graphical cell can represent a data record for a first time measurement interval. In operation 808, the actual data corresponding to the displayed data in the first graphical cell can be displayed at the time position. The method can include displaying the average value of the data attributes associated with the graphical cells displayed on the common timeline. The method can also include marking a graphical cell as an outlier when the data attribute displayed as the graphical cell exceeds a predefined data range. The display of graphical cells can be updated as additional data attributes are received from the plurality of data sources.

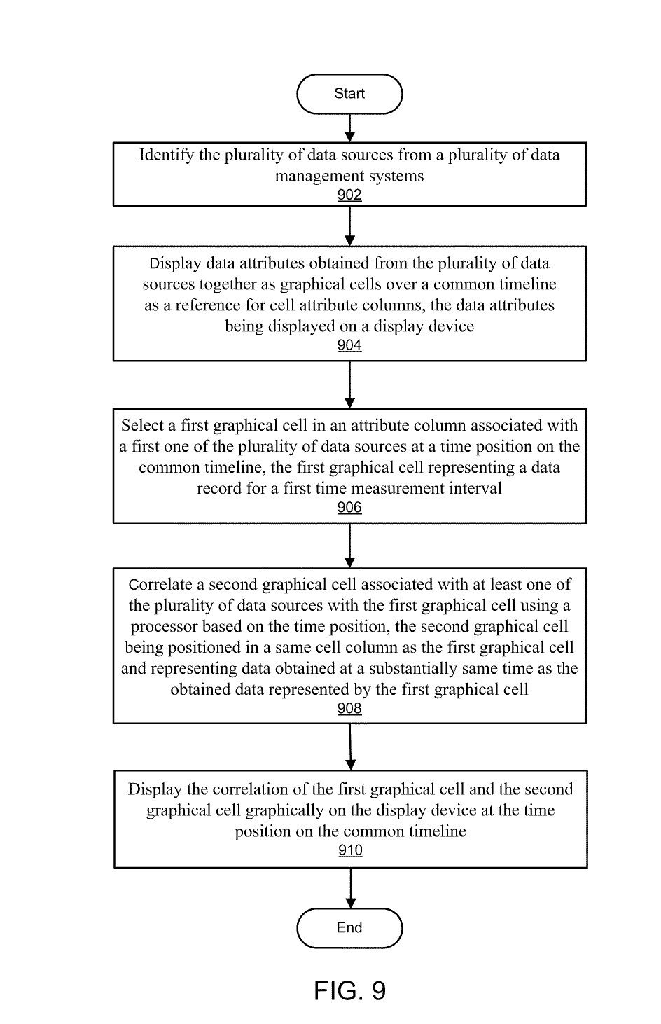

FIG. 9 illustrates a detailed method for correlating data in a visual display from a plurality of data sources in a data management system. In operation 902, the plurality of data sources from a plurality of data management systems can be identified. The data sources may provide data in different formats or provide different types of data. In one aspect, the data management systems may comprise systems in a same location, or systems which are networked together. For example, the systems may include server farms in California, Texas, and other locations. Data attributes obtained from the plurality of data sources can be displayed together as graphical cells over a common timeline as a reference for cell attribute columns, as in operation 904. In operation 906, a first graphical cell in an attribute column associated with a first one of the plurality of data sources at a time position on the common timeline can be selected. The first graphical cell can represent a data record for a first time measurement interval. A second graphical cell associated with at least one of the plurality of data sources can be correlated with the first graphical cell using a processor and based on the time position in operation 908. The second graphical cell can be positioned in a same cell column as the first graphical cell and representing data obtained at a substantially same time as the obtained data represented by the first graphical cell. In operation 910, the correlation of the first graphical cell and the second graphical cell can be displayed graphically on the display device at the time position on the common timeline.

The method may further comprise aggregating the plurality of data sources from a plurality of different servers. Also, the method may allow for display of data attributes from the plurality of data sources in a single view on the display device. For example, the display of data attributes can be configured to fit in a single window on a display screen. The system can be configured to arrange the time line, the time intervals on the time line, and so forth to fit a full view of the display on the screen so that the user does not need to scroll to find particular information. In other aspects, the data is displayed in a single view, such as a single window, but the user may still need to scroll to view at least some of the data. Also, the system may enable a user to zoom in on a particular portion of the display for more detailed viewing. A particular level of zoom may affect the amount of the display visible on the display device without scrolling. The method can also allow for multiple views for the data. For example, FIG. 3 shows three different views which may be available in one or more view windows. Different view windows can be displayed within a larger display or window, or may comprise separate windows. For example, the three different views of FIG. 3 may be displayed within a single view window, and a new window with additional data can be opened when the user performs a drilldown operation.

The present technology may aid a user in identifying problem queries and other problems that impact the performance of a data management system. By visually displaying data attributes, a user can visually correlate the data attributes and identify problems quickly. By quickly identifying problem queries, a user can stop problem queries before they consume large amounts of computational resources, increase the operating speed of the data management system, and increase the efficiency of data storage and retrieval for operators of the data management system.

Also within the scope of an embodiment is the implementation of a program or code that can be stored in a machine-readable medium to permit a computer to perform any of the methods described above. The methods and systems of certain embodiments may be implemented in hardware, software, firmware, or combinations thereof. In one embodiment, the method can be executed by software or firmware that is stored in a memory and that is executed by a suitable instruction execution system. If implemented in hardware, as in an alternative embodiment, the method can be implemented with any suitable technology that is well known in the art.

Other variations and modifications of the above-described embodiments and methods are possible in light of the foregoing disclosure. Further, at least some of the components of an embodiment of the invention may be implemented by using a programmed general purpose digital computer, by using application specific integrated circuits, programmable logic devices, or field programmable gate arrays, or by using a network of interconnected components and circuits.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the present disclosure. Accordingly, it is not intended that the present disclosure be limited, except as by the claims set forth below.

1. A method for aligning data in a visual display from a plurality of data sources, the method comprising:
identifying the plurality of data sources from a plurality of data management systems;
displaying data attributes obtained from the plurality of data sources together as graphical cells over a common timeline as a reference for cell attribute columns, the data attributes being displayed on a display device;
selecting a first graphical cell in an attribute column associated with a first one of the plurality of data sources at a time position on the common timeline, the first graphical cell representing a data record for a first time measurement interval;
aligning a second graphical cell associated with the plurality of data sources with the first graphical cell using a processor based on the time position, the second graphical cell being positioned in a same cell column as the first graphical cell and representing data obtained at a substantially same time as the obtained data represented by the first graphical cell; and
displaying the aligned first graphical cell and second graphical cell graphically on the display device at the time position on the common timeline.

2. A method in accordance with claim 1, further comprising:
correlating the second graphical cell associated with at least one of the plurality of data sources with the first graphical cell using a processor based on the time position, the second graphical cell being positioned in a same cell column as the first graphical cell and representing data obtained at a substantially same time as the obtained data represented by the first graphical cell; and
displaying the correlation of the first graphical cell and the second graphical cell graphically on the display device at the time position on the common timeline.

3. A method in accordance with claim 1, wherein the displayed data attributes comprise a representation of actual data obtained, the method further comprising displaying the actual data corresponding to the displayed data attributes in the first graphical cell at the time position.

4. A method in accordance with claim 3, wherein displaying the actual data further comprises allowing a user to drill down from the graphical cells to view detailed information about the first data attribute.

5. A method as in claim 4, further comprising:
correlating the second graphical cell associated with at least one of the plurality of data sources with the first graphical cell using a processor based on the time position, the second graphical cell being positioned in a same cell column as the first graphical cell and representing data obtained at a substantially same time as the obtained data represented by the first graphical cell;
displaying the correlation of the first graphical cell and the second graphical cell graphically on the display device at the time position on the common timeline; and
allowing the user to drilldown from the graphical cells to view detailed information about the correlated first and second graphical cells.

6. A method as in claim 4, wherein allowing a user to drilldown comprises enabling many to one and one to many display of data attributes by:
allowing the user to select a graphical cell representing an aggregation of data attributes;
identifying a plurality of data attributes comprising the aggregation of data attributes associated with the selected graphical cell; and
displaying the plurality of data attributes associated with the selected aggregation of data attributes.

7. A method as in claim 1, wherein selecting the first graphical cell comprises:
displaying the plurality of data attributes to a user; and
prompting the user to select the data attribute from the plurality of data attributes, wherein the data attribute selected by the user will be displayable on the display device for visual analysis.

8. A method as in claim 1, wherein selecting the first graphical cell comprises:
defining a data attribute selection criteria for selecting data attributes for visual analysis; and
applying the data attribute selection criteria to the plurality of data attributes to select the data attribute that will be displayable for visual analysis.

9. A method as in claim 1, further comprising:
determining a combination criteria to form a quantified display attribute from the data attribute; and
displaying a plurality of graphical cells representative of the quantified display attribute.

10. A method as in claim 9, wherein the combination criteria combines one or more data attributes to form the quantified display attribute.

11. A method as in claim 1, wherein the graphical cell column comprises a column of pixels and the graphical cell comprises a pixel displayed in the column of pixels.

12. A method for viewing data in a visual display from a plurality of data sources, the method comprising:
identifying the plurality of data sources from a plurality of data management systems;
displaying data obtained from the plurality of data sources together as graphical cells using a common timeline as a reference for cell columns, the data being displayed on a display device, the displayed data being a representation of actual data obtained;
selecting a first graphical cell in an attribute column associated with a first one of the plurality of data sources at a time position on the common timeline, the first graphical cell representing a data record for a first time measurement interval; and
displaying the actual data corresponding to the displayed data in the first graphical cell at the time position.

13. A method as in claim 12, wherein the plurality of data sources comprises at least one of a query performance data stream and a system resource performance data stream.

14. A method as in claim 12, further comprising displaying the average value of the data attributes associated with the graphical cells displayed on the common timeline.

15. A method as in claim 12, further comprising marking a graphical cell as an outlier when the data attribute displayed as the graphical cell exceeds a pre defined data range.

16. A method as in claim 12, further comprising selecting the plurality of data sources from a superset of data sources and displaying the selected plurality of data sources on demand to enable method scalability.

17. A method as in claim 12, further comprising assigning a fill pattern to the graphical cells, wherein the fill pattern corresponds to a numeric value of at least one of the data attributes.

18. A method for correlating data in a visual display from a plurality of data sources, the method comprising:
identifying the plurality of data sources from a plurality of data management systems;
displaying data attributes obtained from the plurality of data sources together as graphical cells over a common timeline as a reference for cell attribute columns, the data attributes being displayed on a display device;
selecting a first graphical cell in an attribute column associated with a first one of the plurality of data sources at a time position on the common timeline, the first graphical cell representing a data record for a first time measurement interval;
correlating a second graphical cell associated with at least one of the plurality of data sources with the first graphical cell using a processor based on the time position, the second graphical cell being positioned in a same cell column as the first graphical cell and representing data obtained at a substantially same time as the obtained data represented by the first graphical cell; and
displaying the correlation of the first graphical cell and the second graphical cell graphically on the display device at the time position on the common timeline.

19. A method as in claim 18, wherein the plurality of data sources comprise different formats and different data types and the method further comprises aggregating the plurality of data sources from a plurality of different servers.

20. A method as in claim 18, wherein displaying data attributes further comprises displaying the data attributes in a single view on the display device.
